(19) United States
(12) Patent Application Publication
(10) Pub. No.: US 2026/0027565 A1
(43) Pub. Date: Jan. 29, 2026

(54) PCR PLATE, NUCLEIC ACID EXTRACTION CARTRIDGE AND POLYMERASE CHAIN REACTION DEVICE COMPRISING THE SAME

(71) Applicant: BIONEER CORPORATION, Daejeon (KR)

(72) Inventor: Han Oh Park, Sejong-si (KR)

(73) Assignee: BIONEER CORPORATION, Daejeon (KR)

(21) Appl. No.: 18/349,981

(22) PCT Filed: Apr. 21, 2023
(86) PCT No.: PCT/KR2023/005507

§ 371 Date: Jul. 11, 2023

(51) Int. Cl. B01L 7/00; B01L 3/00

(52) U.S. Cl. CPC B01L 7/52; B01L 3/502; B01L 2200/026; B01L 2200/14; B01L 2300/041; B01L 2300/123; B01L 2300/1805

(57) ABSTRACT

A PCR plate includes: a body having at least one reaction well; an insertion portion extending from the body to be inserted into a nucleic acid extraction cartridge and having an injection port, into which a nucleic acid solution is injected; a flow channel, along which the nucleic acid solution flows from the injection port to the reaction well; and a blocking member mounted on the body and blocking a reverse flow of the nucleic acid solution from the reaction well towards the flow channel.

### TECHNICAL FIELD

The present invention relates to a PCR plate, a nucleic acid extraction cartridge and a polymerase chain reaction device including the same, and more particularly to a PCR plate, a nucleic acid extraction cartridge and a polymerase chain reaction device including the same, which can perform nucleic acid extraction, amplification reaction, and real-time detection of amplified products.

### BACKGROUND ART

Point-of-care (POC) diagnostics for accurate and rapid diagnosis of patient's diseases regardless of time or place is attracting attention as an essential technology for evidence-based precision medicine. Symptom-based on-site diagnosis technology, in which all infectious pathogens causing disease symptoms, such as cough, diarrhea, high fever, genital abnormalities, and the like, are examined based on the symptoms in a rapid time to identify causative pathogens and prescribe optimal antibiotics and treatment, has been developed as a novel core technology for future precision medicine through various studies. Such an on-site diagnosis technology allows rapid and accurate diagnosis by non-experts at the work site, like pregnancy test kits for checking pregnancy and glucose meters for checking blood sugar. Currently, multiplex examination methods capable of simultaneously examining multiple pathogens are being developed and molecular diagnostics using such methods to identify exact cause of infectious diseases and to allow optimal treatment is attracting attention as an essential technology for future medicine, which can improve quality of medical care while reducing medical costs through disease treatment at an early stage and achieving dramatic reduction in recovery period of patients.

However, since a current molecular diagnosis system takes more than 3 hours to obtain diagnosis results and must be used by trained experts, it is essential to develop an automated small device capable of automatically performing complex nucleic acid extraction and real-time gene amplification tests for POC molecular diagnosis required at the work site and can be easily operated even by non-experts.

A representative molecular diagnosis method include a polymerase chain reaction method (hereinafter “PCR method”). The PCR method has been extensively used in molecular biology and molecular diagnostics for its ability to rapidly and easily amplify specific DNA since the PCR method was invented by Kary Mullis in 1985. Since PCR/RT-PCR can determine the presence of specific DNA/RNA in a biological sample, this technology is widely used to diagnose pathogenic microbial infections, such as viruses and the like. The PCR/RT-PCR technology has evolved into real-time quantitative PCR (Real-time PCR, Quantitative PCR) to provide a test result as soon as PCR is finished, and is used as a standard diagnosis method for monitoring effectiveness of treatment for HIV, HCV and HBV viruses, and the like by greatly reducing a test time through simplification of a test procedure while accurately quantifying the number of pathogens. In addition, PCR/RT-PCR is one of the most important techniques for disease diagnosis, since this technology can detect gene expression patterns or genetic variations associated with specific diseases.

For PCR, nucleic acid extraction is performed to extract pure nucleic acids through removal of substances obstructing PCR from a biological sample. Since a nucleic acid extraction process is composed of multiple steps and requires specialized skills in operation of biological samples and nucleic acid extraction and can cause contamination due to operator error when performed manually, most molecular diagnosis is performed using automated nucleic acid extraction equipment.

Since a real-time quantitative PCR device is required for PCR and detection of reactants, molecular diagnosis has been generally performed mainly in large hospitals and clinical examination centers in the art.

Through recent research and development, various automated systems and devices using the same have been developed to achieve easy use of PCR even without specialized skills through automation of the entire processes of nucleic acid extraction, PCR and reactant detection.

However, existing devices are either too expensive or too time-consuming to perform multiple examinations simultaneously.

According to the basic principle of PCR, when a PCR solution is heated to 95° C. to separate the DNA double helix into single strands and is cooled to an annealing temperature such that complementary primers in the PCR solution selectively hybridize to opposite ends of a site to be amplified, the DNA polymerase repeats reaction of forming a double helix through sequential attachment of the four nucleotide triphosphates A, G, T and C to each single strand. PCR is a process of exponentially amplifying a specific DNA double helix by 2n through 30 to 45 cycles (n) of heating and cooling the PCR solution. RT-PCR has been expanded to a method for RNA detection by allowing cDNA to be synthesized through reverse transcription and to be amplified through PCR.

According to the principle of real-time quantitative PCR newly developed to fully utilize PCR for molecular diagnosis, for quantitative analysis of DNA amplified by PCR, a substance capable of fluorescing in proportion to the amount of DNA is added to a PCR solution and the fluorescence value is measured at each cycle to find a cycle at which a threshold fluorescence value is detected for quantitative measurement of an initial concentration of target nucleic acid.

During development of various application technologies since invention of the PCR method, a great number of pathogens and disease-related gene sequences have been known through the genome project and molecular diagnostics for qualitative and quantitative diagnosis of diseases through amplification of such disease-related DNA/RNA sequences has been rapidly developed. Since conventional PCR takes about 2 hours for cycling of temperatures, various methods have been continuously developed to perform PCR faster and more accurately for in-situ diagnosis (Lab Chip, 2016, 16, 3866-3884).

For rapid PCR, it is necessary to achieve rapid change in temperature of a reaction solution. In addition, for amplification of only the desired target through accurate PCR, primers must be specifically bound to the desired target and accurate control of the annealing temperature is required in PCR temperature cycling.

To this end, micro-PCR reactors having smaller heat capacity and better heat transfer than typical 0.2 ml and 0.5 ml reactors used in laboratories have been developed in the art. Such micro-PCR reactors use less reaction solution and have a large surface area, thereby allowing rapid heating and cooling through rapid heat transfer. Although the surface area of the micro-reactors was kept large (>100 mm²/10 μl) by placing 10 μl of a PCR solution in a 40 to 80 μm thick reaction groove formed in a size of 17×15 mm on a silicon wafer and covering the reaction groove with a glass plate, the micro-PCR reactors failed to reduce the time for one cycle which takes about 3 minutes for an existing Peltier type thermal block (Clin. Chem. 40/9, 1815-1818 (1994)).

In early PCR equipment, PCR reactors were repeatedly immersed in hot and cold water baths to achieve rapid heat cycling of the PCR reactor (Turbo Thermal Cycler, Bioneer Corp. Daejeon). Such PCR equipment adapted to circulate the reactors in different temperature zones is a spatially movable type and allows rapid and accurate PCR by immersing the reactors in the constant temperature water baths, which are precisely maintained at constant temperature in advance. However, this equipment requires multiple constant temperature water baths, causing increase in size of the equipment and difficult maintenance, and dominantly adopts a time-differential temperature cycling method that changes the temperature over time using Peltier elements in stationary blocks.

A PCR method using micro-channels was developed for a spatially movable temperature cycling method and a time-differential temperature cycling method. The spatially movable temperature cycling method can be generally classified into an open type method, which is a first-in-first-out (FIFO) type allowing continuous flow, and a closed type method, in which the PCR reactors are repeatedly moved between different temperature zones. The open type method was developed by Nakano et al. in 1994 and allows continuous flow of a PCR solution through a capillary wrapped around a cylindrical block having compartments with different temperatures (Biosci. Biotech. Biochem., 58(2), 349-352, 1994). It was confirmed by Kopp et al. in 1998 that PCR was carried out by 20 cycles of allowing 10 μl of a solution to pass through micro-channel type PCR equipment that guides the solution to repeatedly pass through different temperature zones, in which each cycle takes 4.5 seconds (Science 280 1046-1048, 1998).

The background technique of the present invention is disclosed in Korean Patent Publication No. 10-2016-0067872 (Publication Date: Jun. 14, 2016, Title of the invention: Analysis unit and analysis device for polymerase chain reaction, operation method thereof and method for manufacturing the analysis unit).

Korean Patent Registration No. 10-2105558 discloses a high speed polymerase chain reaction analysis plate. However, in use of the analysis plate disclosed therein, amplified products in adjacent reaction wells can be mixed in a PCR process, thereby causing deterioration in accuracy of an experiment. To solve such a problem, there is a need for an improved PCR plate capable of rapidly quantitatively and qualitatively analyzing a number of targets.

### DISCLOSURE

### Technical Problem

The present invention has been conceived to solve such problems in the art and it is one object of the present invention to provide a PCR plate, a nucleic acid extraction cartridge, and a polymerase chain reaction device including the same, which can fully automatically perform detection of target nucleic acids in real time through extraction of the nucleic acids from a biological sample, PCR and scanning of excitation light and corresponding fluorescence in various wavelength bands, can examine multiple targets in single operation, can secure convenient use, and can obtain accurate results in a particularly short time.

It is another object of the present invention to provide a PCR plate, a nucleic acid extraction cartridge, and a polymerase chain reaction device including the same, which can maximize reaction reliability through rapid and accurate PCR by enabling rapid and repeated application of exact temperatures for a thermal denaturation process and an annealing process to a reaction object in a temperature control process required for a PCR process.

### Technical Solution

In accordance with one aspect of the present invention, a PCR plate includes: a body having at least one reaction well; an insertion portion extending from the body to be inserted into a nucleic acid extraction cartridge and having an injection port, into which a nucleic acid solution is injected; a flow channel, along which the nucleic acid solution flows from the injection port to the reaction well; and a blocking member mounted on the body and blocking a reverse flow of the nucleic acid solution from the reaction well towards the flow channel.

The body may include: a body frame having the at least one reaction well; a blocking member-receiving portion concavely formed on the body frame and receiving the blocking member therein; a connecting channel connecting the blocking member-receiving portion to the reaction well; a storage portion concavely formed on the body to communicate with the flow channel and receiving the nucleic acid solution supplied thereto; and a channel guide communicating with the storage portion and guiding the nucleic acid solution to flow toward the blocking member.

The connecting channel may have a bottleneck formed from the blocking member towards the reaction well and having a narrow width.

The blocking member-receiving portion may be divided into multiple blocking member-receiving portions by a partition formed in a longitudinal direction of the storage portion and the blocking member may be mounted on each of the divided blocking member-receiving portions.

The blocking member may include an elastic material.

The body may include: a body frame having the at least one reaction well; a blocking member-receiving portion concavely formed on the body frame, disposed corresponding to each reaction well, and formed in a circular shape to receive the blocking member having a circular shape; and a connecting channel connecting the blocking member-receiving portion to the reaction well.

The blocking member may include an elastic material.

A sheet member may be joined to the reaction well by thermal fusion.

In accordance with another aspect of the present invention, a nucleic acid extraction cartridge includes: a cartridge cover formed with a plurality of receptacles each receiving a solution for DNA extraction and having a partition structure; and a cartridge body coupled to the cartridge cover through an insertion structure and formed with a reaction receptacle in which the solution supplied from the receptacle reacts with a specimen or is purified.

The cartridge cover may include a rubber portion contacting one side surface of each of the receptacles of the cartridge body and including an elastic material.

The nucleic acid extraction cartridge may be provided with an anti-leakage rubber member including an elastic material and preventing leakage of the nucleic acid solution.

In accordance with a further aspect of the present invention, a nucleic acid extraction cartridge assembly includes: a nucleic acid extraction cartridge; and a PCR plate receiving a nucleic acid solution supplied from the nucleic acid extraction cartridge in a reaction well receiving a dried PCR mixture, wherein the nucleic acid extraction cartridge includes: a cartridge cover formed with a plurality of receptacles each receiving a solution for DNA extraction and having a partition structure; and a cartridge body coupled to the cartridge cover through an insertion structure and formed with a reaction receptacle in which the solution supplied from the receptacle reacts with a specimen or is purified, and wherein the PCR plate includes: a body having at least one reaction well; an insertion portion extending from the body to be inserted into the nucleic acid extraction cartridge and having an injection port, into which the nucleic acid solution is injected; a flow channel, along which the nucleic acid solution flows from the injection port to the reaction well; and a blocking member mounted on the body and blocking a reverse flow of the nucleic acid solution from the reaction well towards the flow channel.

The cartridge cover may include a rubber portion contacting one side surface of each of the receptacles of the cartridge body and including an elastic material.

The nucleic acid extraction cartridge may be provided with an anti-leakage rubber member including an elastic material and preventing leakage of the nucleic acid solution.

In accordance with yet another aspect of the present invention, a polymerase chain reaction device includes: a nucleic acid extraction cartridge; and a PCR plate receiving a nucleic acid solution supplied from the nucleic acid extraction cartridge in a reaction well receiving a dried PCR mixture, wherein the nucleic acid extraction cartridge includes: a cartridge cover formed with a plurality of receptacles each receiving a solution for DNA extraction and having a partition structure; and a cartridge body coupled to the cartridge cover through an insertion structure and formed with a reaction receptacle in which the solution supplied from the receptacle reacts with a specimen or is purified, and wherein the PCR plate includes: a body having at least one reaction well; an insertion portion extending from the body to be inserted into the nucleic acid extraction cartridge and having an injection port, into which the nucleic acid solution is injected; a flow channel, along which the nucleic acid solution flows from the injection port to the reaction well; and a blocking member mounted on the body and blocking a reverse flow of the nucleic acid solution from the reaction well towards the flow channel.

The cartridge cover may include a rubber portion contacting one side surface of each of the receptacles of the cartridge body and including an elastic material.

The nucleic acid extraction cartridge may be provided with an anti-leakage rubber member including an elastic material and preventing leakage of the nucleic acid solution.

### Advantageous Effects

According to the present invention, it is possible to achieve fully automatic real-time detection of reaction products through extraction of nucleic acids from a biological sample, PCR and scanning of excitation light and corresponding fluorescence in various wavelength bands, to perform variation examinations in single operation, to secure convenient use, and to obtain accurate results in a short time.

In addition, the PCR plate can prevent a reverse flow of a dried PCR mixture from reaction wells, thereby preventing contamination due to flow of the PCR mixture to adjacent reaction wells.

Further, according to the present invention, it is possible to maximize reaction reliability through accurate PCR by enabling rapid and real-time application of exact temperatures for a thermal denaturation process and an annealing process to a reaction object in a temperature control process required for a PCR process.

Since a conventional temperature control method allows increase in temperature while moving a reaction solution, the conventional temperature control method is disadvantageous for PCR due to non-uniform increase in temperature and cannot realize a uniform temperature in the entirety of a reaction product by allowing sequential increase in temperature during movement of the reaction solution, thereby causing another reaction. However, the present invention prevents such a problem by maintaining heating blocks at constant temperatures and can very efficiently raise the temperature for PCR in a way of directly compressing the entirety of the reaction solution.

Furthermore, in order to minimize time delay in a process of changing the temperature from high temperature to low temperature, heating blocks are arranged parallel to each other and are relocated upon compression of the PCR plate such that the PCR plate can be compressed in real time by the heating blocks with different temperatures, thereby efficiently solving the problem of time delay that can inevitably occur in the temperature change process.

Furthermore, since the PCR plate is implemented as an insertable structure in the nucleic acid extraction cartridge, the nucleic acid extraction cartridge may be commonly used, and among PCR plates for various examination kits stored in a narrow space, a suitable PCR plate may be selected and used upon examination, as needed. The PCR plate allows up to six fluorescence values to be analyzed in a single reaction well therein and may be formed with up to eight reaction wells, as needed, thereby enabling a symptom-based multiplexed molecular diagnosis examination through amplification and detection of all pathogens likely to be present in a patient's biological sample associated with symptoms.

In addition, according to the present invention, the constant temperature plate is divided into a region having a first temperature and a region having a second temperature and is moved to allow a region having a preset temperature (first temperature or second temperature) corresponding to a temperature of a heating block to face the heating block upon compression of the heating block, whereby the upper and lower surfaces of the PCR plate can be simultaneously compressed through contact therewith, thereby realizing two times higher efficiency than a constant temperature plate maintained at a constant temperature.

Further, in implementation of a movable constant temperature plate, a sliding tape may be used as a component for driving operation to secure reliability of constitution and movement of a product, and upper and lower surfaces of a plate placed in a target may be simultaneously heated, thereby enabling reduction in examination time.

### DESCRIPTION OF DRAWINGS

FIG. 1 is a block diagram of a polymerase chain reaction device according to an embodiment of the present invention.

FIG. 2 to FIG. 7 are views of a temperature control module according to an embodiment of the present invention.

FIG. 8 to FIG. 13 are views of a PCR plate according to one embodiment of the present invention.

FIG. 14 to FIG. 19 are views of a PCR plate according to another embodiment of the present invention.

FIG. 20 to FIG. 23 are conceptual views illustrating structure and operation of a constant temperature plate and a horizontal movement drive module according to an embodiment of the present invention.

FIG. 24 is a perspective view of a nucleic acid extraction cartridge according to an embodiment of the present invention, into which the PCR plate is inserted.

FIG. 25 is an exploded perspective view of the nucleic acid extraction cartridge shown in FIG. 24.

FIG. 26 is a view illustrating an inner structure of a cartridge cover shown in FIG. 24.

FIG. 27 is an inner perspective view of the nucleic acid extraction cartridge shown in FIG. 24 in a coupled state.

FIG. 28 is an assembled perspective view of a nucleic acid extraction cartridge according to another embodiment of the present invention.

FIG. 29 is a sectional view of the nucleic acid extraction cartridge according to the other embodiment of the present invention.

FIG. 30 to FIG. 32 are views illustrating a lower part of a cartridge structure according to the present invention in operation.

FIG. 33 is a view illustrating an overall structure of a polymerase chain reaction device according to an embodiment of the present invention.

FIG. 34 is an enlarged view of a main part of the polymerase chain reaction device shown in FIG. 33.

FIG. 35 is a vertical sectional view of the main part shown in FIG. 34.

FIG. 36 is a lateral perspective sectional view of the main part shown in FIG. 35.

FIG. 37 is a perspective conceptual view of a nucleic acid extraction cartridge according to another embodiment of the present invention.

FIG. 38 is a sectional view of the nucleic acid extraction cartridge shown in FIG. 37.

FIG. 39 is a view illustrating operation of punching an anti-leakage rubber member by a punch in the nucleic acid extraction cartridge shown in FIG. 38.

FIG. 40 is a view illustrating operation of pressing an anti-leakage rubber member by a pressing jig in FIG. 39.

FIG. 41 is a view of the anti-leakage rubber member preventing leakage of remaining liquid.

FIG. 42 is a view of a PCR plate according to a further embodiment of the present invention.

FIG. 43 is a sectional view of the PCR plate shown in FIG. 42.

FIG. 44 is a view of the PCR plate with a sheet member mounted thereon.

FIG. 45 is a view illustrating a test to check mixing of solutions between reaction wells in PCR.

FIG. 46 is a view illustrating a test to check mixing of solutions between the reaction wells on a PCR plate.

### BEST MODE

Hereinafter, exemplary embodiments of the present invention will be described with reference to the accompanying drawings. It should be noted that the drawings are not to precise scale and may be exaggerated in thickness of lines or size of components for descriptive convenience and clarity only.

In addition, the terms as used herein are defined by taking functions of the invention into account and can be changed according to the custom or intention of users or operators. Therefore, definition of the terms should be made according to the overall disclosure set forth herein.

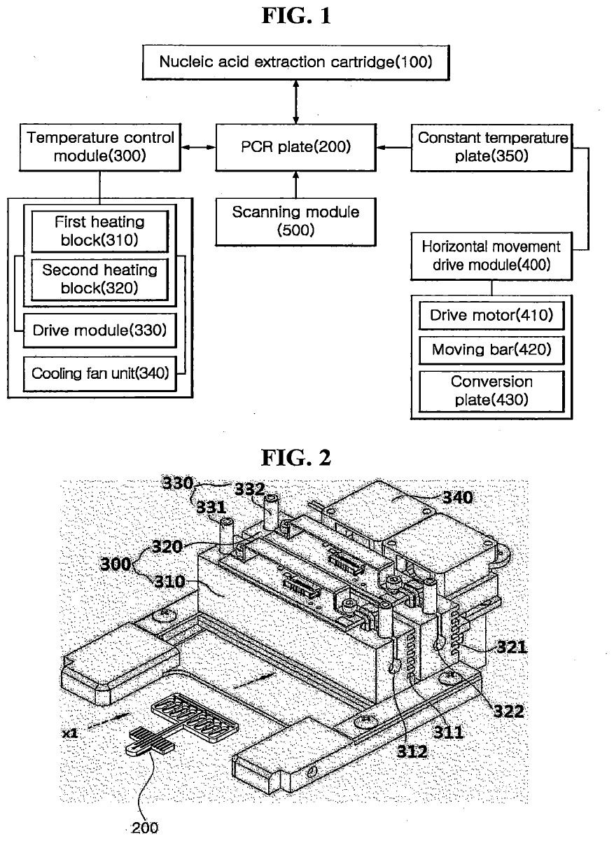

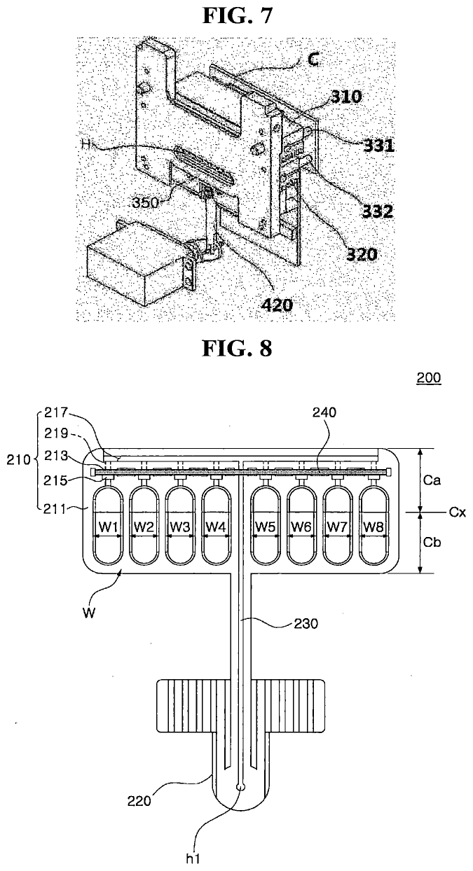

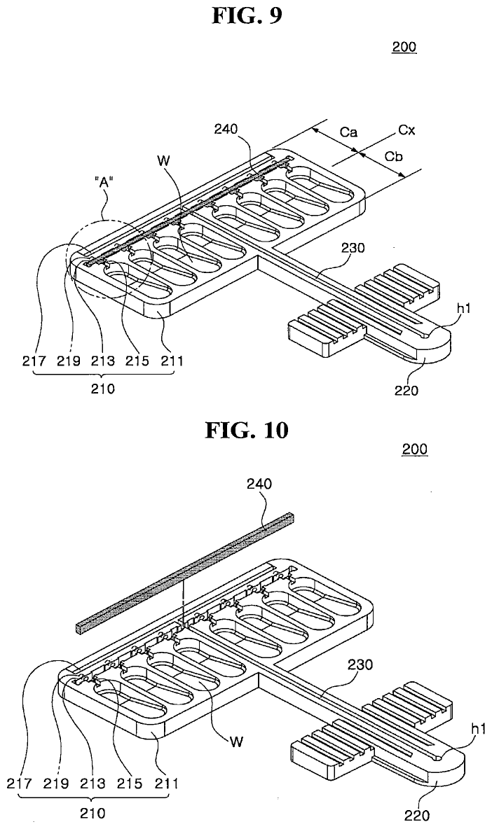

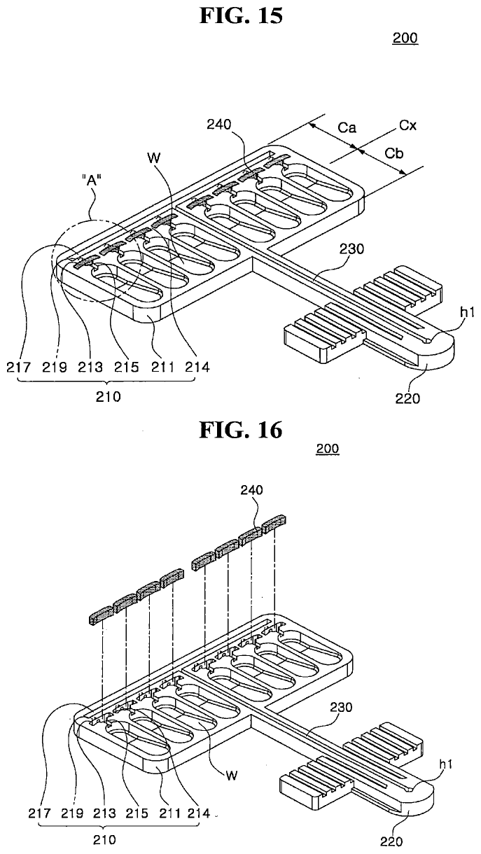

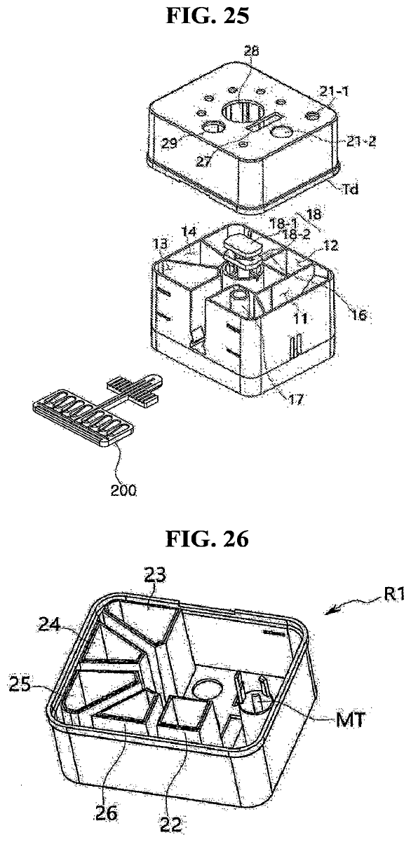

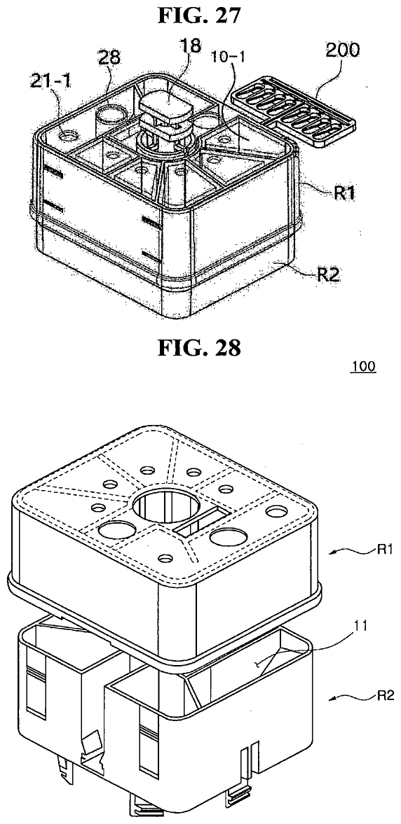

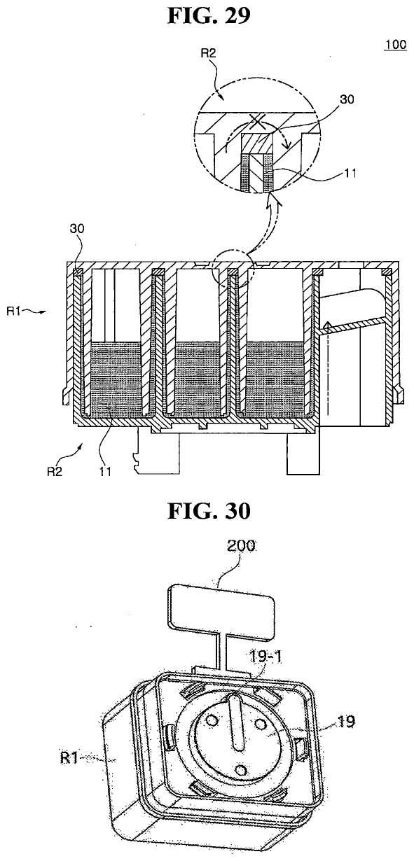

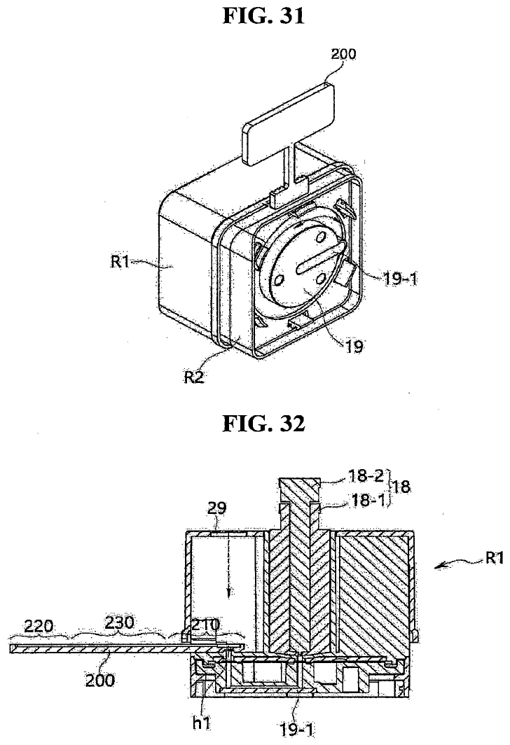

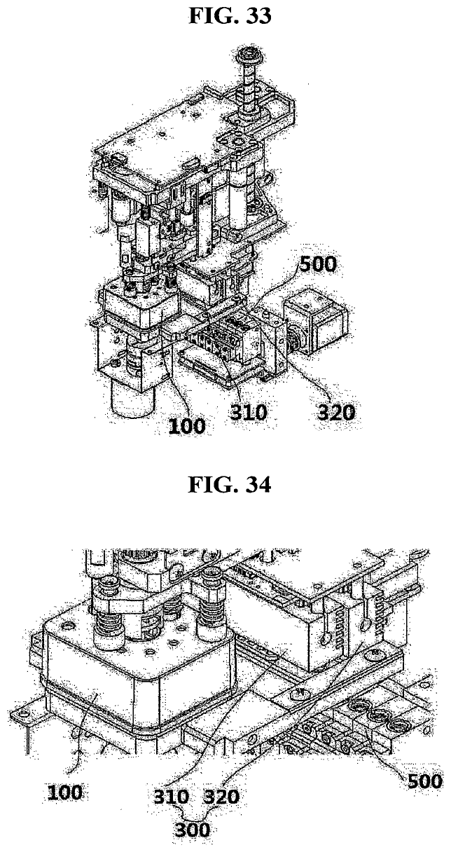

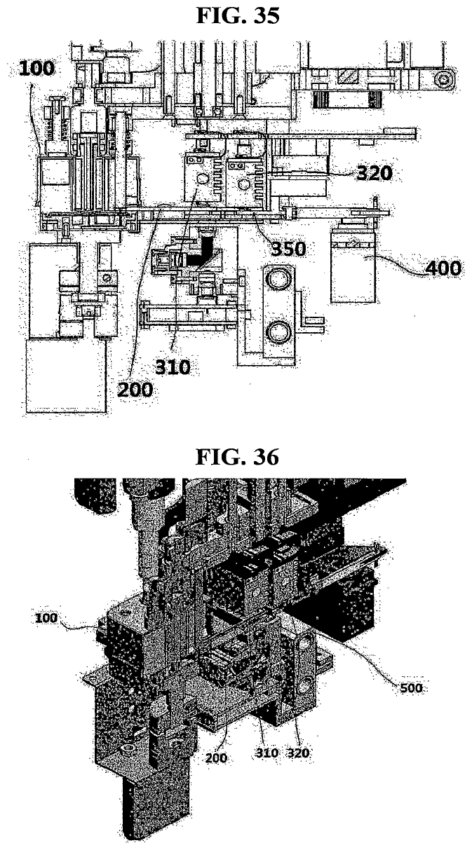

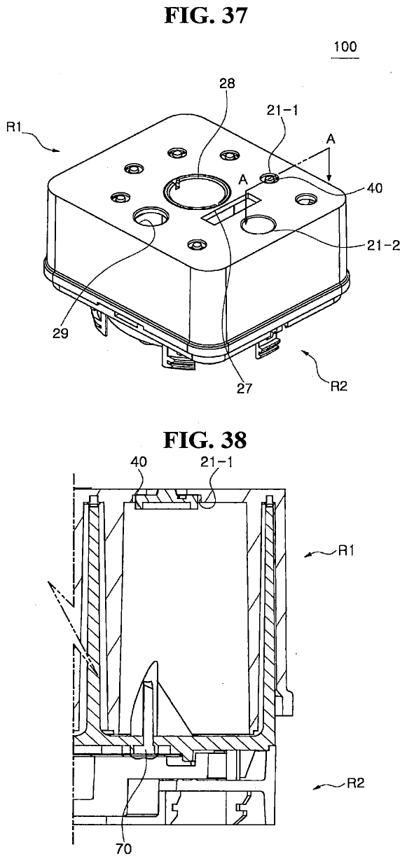

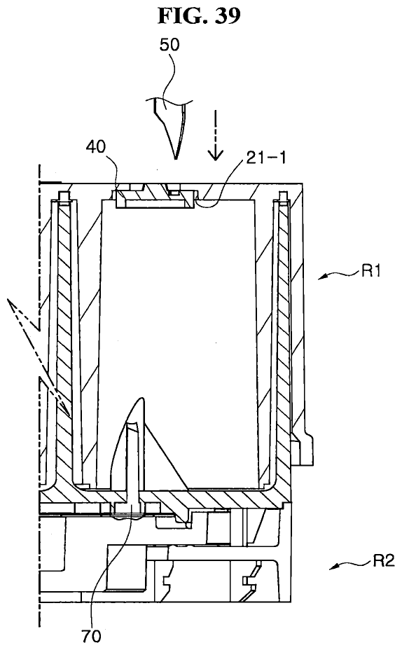

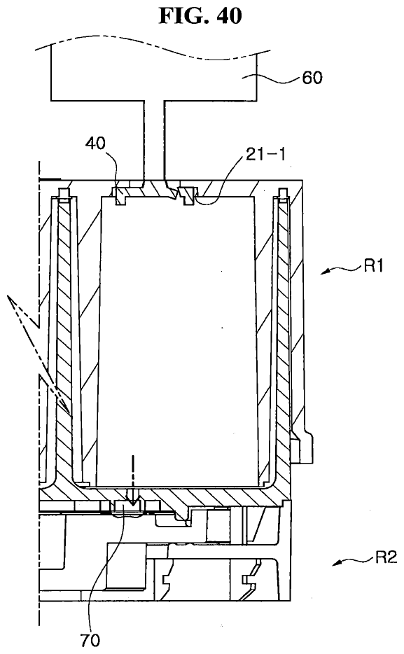

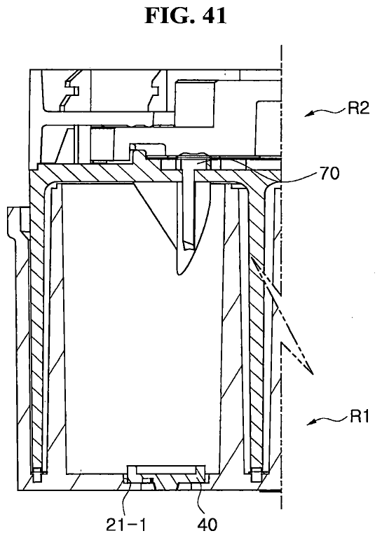

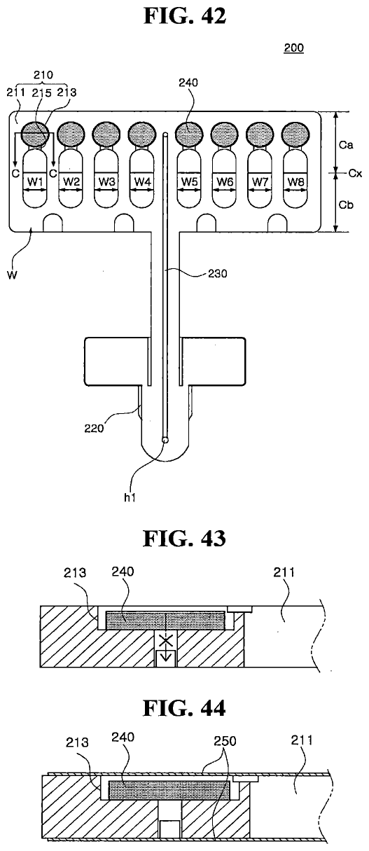

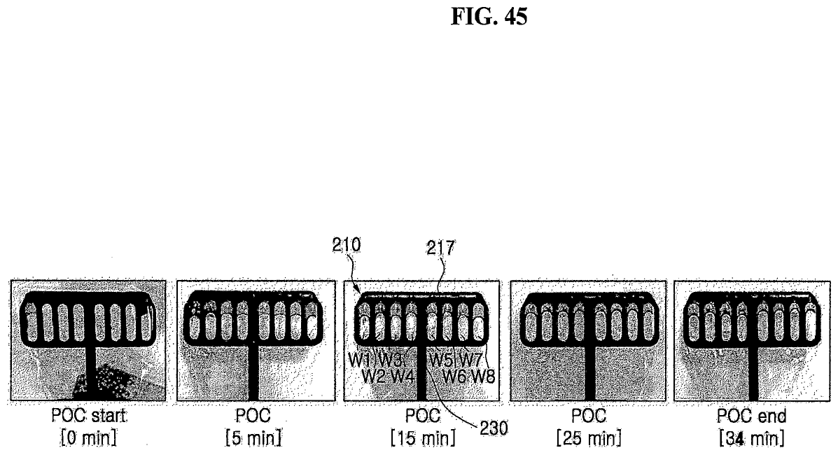

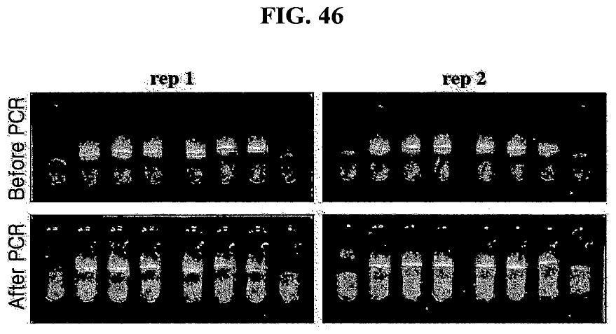

FIG. 1 is a block diagram of a polymerase chain reaction device according to an embodiment of the present invention; FIG. 2 to FIG. 7 are views of a temperature control module according to an embodiment of the present invention; FIG. 8 to FIG. 13 are views of a PCR plate according to one embodiment of the present invention; FIG. 14 to FIG. 19 are views of a PCR plate according to another embodiment of the present invention; FIG. 20 to FIG. 23 are conceptual views illustrating structure and operation of a constant temperature plate and a horizontal movement drive module according to an embodiment of the present invention; FIG. 24 is a perspective view of a nucleic acid extraction cartridge according to an embodiment of the present invention, into which the PCR plate is inserted; FIG. 25 is an exploded perspective view of the nucleic acid extraction cartridge shown in FIG. 24; FIG. 26 is a view illustrating an inner structure of a cartridge cover shown in FIG. 24; FIG. 27 is an inner perspective view of the nucleic acid extraction cartridge shown in FIG. 24 in a coupled state; FIG. 28 is an assembled perspective view of a nucleic acid extraction cartridge according to another embodiment of the present invention; FIG. 29 is a sectional view of the nucleic acid extraction cartridge according to the other embodiment of the present invention; FIG. 30 to FIG. 32 are views illustrating a lower part of a cartridge structure according to the present invention in operation; FIG. 33 is a view illustrating an overall structure of a polymerase chain reaction device according to an embodiment of the present invention; FIG. 34 is an enlarged view of a main part of the polymerase chain reaction device shown in FIG. 33; FIG. 35 is a vertical sectional view of the main part shown in FIG. 34; FIG. 36 is a lateral perspective sectional view of the main part shown in FIG. 35; FIG. 37 is a perspective conceptual view of a nucleic acid extraction cartridge according to another embodiment of the present invention; FIG. 38 is a sectional view of the nucleic acid extraction cartridge shown in FIG. 37; FIG. 39 is a view illustrating operation of punching an anti-leakage rubber member by a punch in the nucleic acid extraction cartridge shown in FIG. 38; FIG. 40 is a view illustrating operation of pressing an anti-leakage rubber member by a pressing jig in FIG. 39; FIG. 41 is a view of the anti-leakage rubber member preventing leakage of residue liquid; FIG. 42 is a view of a PCR plate according to a further embodiment of the present invention; FIG. 43 is a sectional view of the PCR plate shown in FIG. 42; FIG. 44 is a view of the PCR plate with a sheet mounted thereon; FIG. 45 is a view illustrating a test to check mixing of solutions between reaction wells in PCR; and FIG. 46 is a view of a mixed flow test of the reaction well on a PCR plate.

Referring to FIG. 1, a polymerase chain reaction device according to an embodiment of the present invention may include a temperature control module implemented by a heating block structure that applies a particular temperature to a PCR plate through contact therewith so as to allow accurate PCR by enabling rapid and real-time simultaneous application of exact temperatures for a thermal denaturation process and an annealing process to a reaction object without time delay in a temperature control process for PCR while maximizing reaction reliability.

In order to minimize time delay in a process of changing the temperature from a first temperature to a second temperature lower than the first temperature or from the second temperature to the first temperature, the temperature control module according to the present invention enables compression of the PCR plate in real time by changing the locations of heating blocks set to the first temperature and the second temperature, respectively, thereby remarkably suppressing time delay in the temperature change process.

Furthermore, according to the present invention, the polymerase chain reaction device may further include a constant plate structure disposed under the PCR plate and horizontally moving in a sliding manner. With this structure, the constant plate structure maintains the temperature of the PCR plate at a first temperature or at a second temperature, thereby maximizing a reaction rate through minimization of time required for application of temperature change conditions.

The polymerase chain reaction device according to the embodiment includes: a PCR plate 200 receiving a nucleic acid solution supplied from a nucleic acid extraction cartridge 100 in reaction wells W receiving a dried PCR mixture; and a temperature control module 300 disposed at one side of the PCR plate 200 and including a pair of heating blocks 310, 320 placed near the reaction wells W to apply different temperatures to the reaction wells W and movable in a horizontal direction and in a vertical direction. The PCR plate 200 may include: a body 210 having one or more reaction wells W; an insertion portion 220 extending from the body 210 to be inserted into the nucleic acid extraction cartridge 100 and having an injection port h1, into which a nucleic acid solution is injected; a flow channel 230, along which the nucleic acid solution flows from the injection port h1 to the reaction wells W; and a blocking member 240 mounted on the body 210 and blocking a reverse flow of the nucleic acid solution from the reaction wells W towards the flow channel 230.

With the structure described above, the present invention provides convenience of allowing nucleic acid extraction to be freely carried out even by non-expert users by inputting a target specimen through the nucleic acid extraction cartridge 100 and can achieve rapid and accurate temperature control using the heating blocks 310, 320 capable of directly applying target temperatures to a reaction solution in the PCR plate 200 through a thin film and compression upon temperature cycling for amplification applied to the PCR plate 200.

In addition, the present invention provides a polymerase chain reaction (hereinafter, “PCR”) device realized by a single system so as to allow detection of a reaction product through a scanning module capable of scanning excitation light and corresponding fluorescence in various wavelength bands in real time under the PCR plate 200.

FIG. 2 to FIG. 7 are views of the temperature control module 300 according to the present invention.

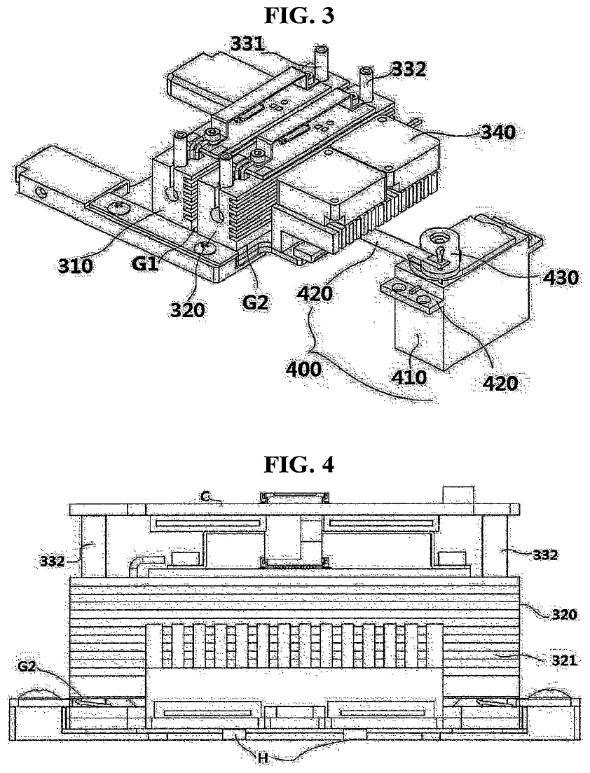

FIG. 2 and FIG. 3 are schematic perspective views of the temperature control module according to the present invention.

Referring to FIG. 2 and FIG. 3, the temperature control module 300 performs a function of controlling the temperature of the PCR plate 200, which receives a PCR (polymerase chain reaction) preliminary mixture or a nucleic acid solution supplied from the nucleic acid extraction cartridge 100 that extracts nucleic acids from a biological sample and mixes the nucleic acid with polymerase.

The temperature control module 300 may include a first heating block 310, which has a first compressive surface G1 corresponding to surfaces of the reaction wells W formed on the PCR plate 200 and is maintained at a preset temperature for thermal denaturation (hereinafter referred to as “first temperature”) by a heating unit. In addition, the temperature control module 300 may further include a second heating block 320, which is spaced apart from the first heating block 310 so as to face the first heating block 310, has a second compressive surface G2 corresponding to the surfaces of the reaction wells, and is maintained at a preset temperature for annealing (hereinafter referred to as “second temperature”) by the heating unit. Particularly, the first heating block 310 and the second heating block 320 are configured to allow horizontal movement and vertical movement.

In one embodiment, each of the first heating block 310 and the second heating block 320 may have a three-dimensional structure and a flat compressive surface on a lower surface thereof. The first heating block 310 and the second heating block 320 may be spaced apart from each other and may have different temperatures.

As shown in FIG. 2 and FIG. 3, the first heating block 310 and the second heating block 320 face each other and are each provided at upper portions thereof with a three-dimensional parallelepiped structure having a flat structure for performing a pressing function on an upper surface thereof. Here, the three-dimensional parallelepiped structure is provided by way of example and the first and second heating blocks according to the present invention may have any three-dimensional shape having a flat compressive surface for pressing.

In addition, the first heating block 310 and the second heating block 320 may be disposed laterally such that adjacent sides thereof are spaced apart from each other, and may be maintained at different temperatures.

For example, the first temperature of the first heating block 310 may be set to a temperature in the range of 94° C. to 96° C. corresponding to the temperature for thermal denaturation, by which double-helix DNA (including DNA extracted from a biological sample) is split into two strands. For example, the first heating block 310 may be maintained at 95° C.

In addition, the second temperature of the second heating block 320 may be set to a temperature in the range of 50° C. to 65° C. corresponding to the temperature for primer annealing, by which primers are bound to split template DNA. For example, the second heating block 320 may be maintained at 55° C.

Each of the first heating block 310 and the second heating block 320 has a metallic body structure having high heat capacity and good heat transfer efficiency instead of receiving water or a heat transfer liquid therein and thus can be maintained at a preset temperature by the heating unit therein. To this end, the heat unit is provided therein with a temperature sensor to maintain a preset temperature through temperature control.

That is, when the PCR preliminary mixture or the nucleic acid solution is injected into the PCR plate 200 and application of the first temperature is required, the first heating block 310 is horizontally moved towards the PCR plate 200 to be placed near the surface of the PCR plate 200. That is, since the first compressive surface G has a flat structure, the entire surface of the PCR plate 200 is simultaneously heated to the same temperature under the same pressure, thereby enabling uniform heat transfer to all samples.

In addition, when application of the second temperature is required for annealing, the second heating block 320 is horizontally moved to be placed above the PCR plate 200, the entire surface of the PCR plate 200 is simultaneously heated to the same temperature under the same pressure.

That is, since no time is required to prepare for a set temperature reaction and the entire surface of the PCR plate 200 is simultaneously heated to the same temperature under the same pressure through simple horizontal movement, it is possible to induce rapider and more accurate PCR than a typical method for controlling the preset temperature.

Since the first heating block 310 and the second heating block 320 are set to different temperatures, the second heating block 320 may be heated by radiant or conduction heat of the first heating block 310 at any time, a cooling fan unit 340 may be disposed in a space between the two structures to provide a cooling effect.

As it is important for the second heating block 320 to maintain the second temperature, for example, an annealing temperature of 55° C., the second heating block 320 may be formed on an upper surface thereof with a dissipation type cooling pattern in order to minimize thermal interference of the first heating block 310 while allowing dissipation of excessive heat in operation of the cooling fan unit. By way of example, the second heating block 320 may further include a temperature adjusting pattern 321 on a lateral side of the second compressive surface G2. The temperature adjusting pattern 321 is a pattern of protrusions formed on an upper side thereof and can increase a contact area with air to improve heat dissipation efficiency advantageous for maintaining a constant low temperature.

Unlike a method of moving a reaction sample for PCR or moving the reaction sample to another heating zone through time setting, the present invention can realize accurate application of the first temperature and the second temperature by adopting the heating blocks such that a uniform temperature can be simultaneously achieved at an upper portion, with the reaction sample secured.

Furthermore, according to the present invention, the first heating block 310 or the second heating block 320 may be interlinked with a drive module 330 that realizes horizontal movement or vertical movement thereof. The drive module 330 includes guide members 331, 332 that penetrate the first heating block 310 and the second heating block 320, respectively, such that the first heating block 310 and the second heating block 320 can move upwards or downwards along the guide members 331, 332.

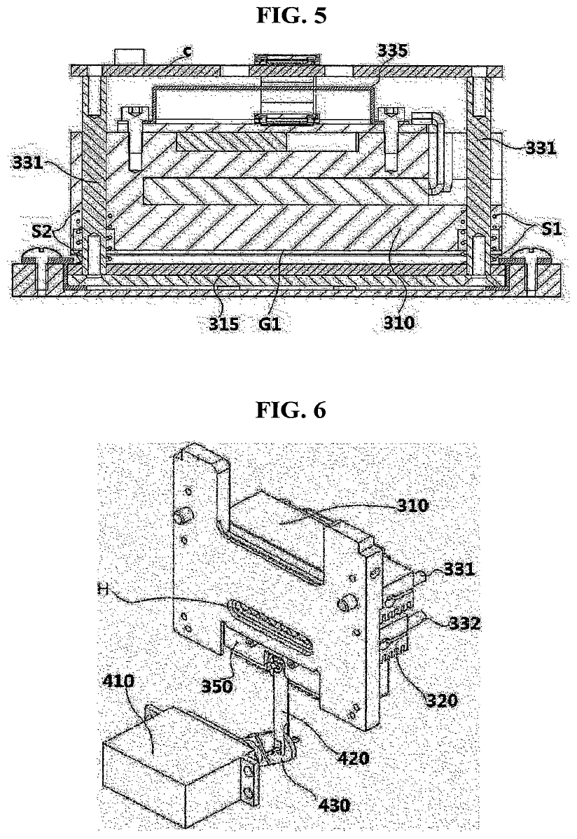

That is, according to the present invention, the first heating block 310 and the second heating block 320 are spaced apart from each other and realize vertical movement to cross each other according to operation of the drive module 330. In addition, the polymerase chain reaction device according to the present invention may further include resilient members S1, S2 disposed under the guide members 331, 332 to provide buffering operation by imparting suitable resilient force upon compression of the PCR plate 200 by the heating blocks 310, 320 (see FIG. 5).

In addition, the polymerase chain reaction device according to the embodiment may further include a constant temperature plate 350 interlinked with the temperature control module 300.

As shown in FIG. 2 and FIG. 3, the constant temperature plate 350 is disposed under the heating blocks 310, 320 constituting the temperature control module 300 and may have the same temperature as the first heating block 310 or the second heating block 320 when the first heating block 310 or the second heating block 320 of the temperature control module 300 compresses the PCR plate 200 through horizontal movement and vertical movement after the PCR plate 200 enters the polymerase chain reaction device.

To this end, the constant temperature plate 350 may further include a horizontal movement drive module 400 that horizontally moves under the PCR plate 200.

To this end, the constant temperature plate 350 may further include a horizontal movement drive module 400 that horizontally moves under the PCR plate 200.

Referring to FIG. 2 and FIG. 3, the horizontal movement drive module 400 may include a drive motor 410 and a moving bar 420 coupled to one end of the constant temperature plate 350, and a conversion plate 430 converting rotation of the drive motor 410 into horizontal movement of the moving bar 420.

The horizontal movement drive module 400 allows the constant temperature plate 350 to horizontally move to a place under the temperature control module 300. In particular, the constant temperature plate 350 according to an embodiment of the invention may be divided into a first region heated to a first temperature and a second region spaced apart from the first region and heated to a second temperature.

In particular, according to the embodiment of the invention, the temperature control module 300 may be integrally formed with the constant temperature plate 350 via the guide members 331, 332.

That is, upon operation of the horizontal movement drive module 400, the constant temperature plate 350 may be moved together with the temperature control module 300 including the heating blocks 310, 320.

In this case, the constant temperature plate 350 may include the first region heated to the first temperature and the second region heated to the second temperature, and the first compressive surface G1 of the first heating block 310 may be dispose to face an upper surface of the first region such that upper and lower surfaces of the PCR plate 200 can be simultaneously compressed at the same temperature, with the PCR plate 200 disposed between the constant temperature plate 350 and the heating blocks 310, 320.

That is, according to this embodiment, the constant temperature plate 350 is divided into a region having a first temperature and a region having a second temperature and is horizontally moved in a sliding manner upon compression of the heating blocks through the horizontal movement drive module 400 to allow a region of the constant temperature plate 350 having a preset temperature (first temperature or second temperature) corresponding to the temperature of the heating block 310 or 320 to face the corresponding heating block, whereby the upper and lower surfaces of the PCR plate can be simultaneously compressed through contact therewith, thereby realizing two times higher efficiency than the constant temperature plate 350 maintained at a constant temperature.

FIG. 4 is a rear sectional view of the temperature control module shown in FIG. 3 and FIG. 5 is a front sectional view of the temperature control module.

As such, the temperature control module 300 according to the present invention includes the drive module 330 realizing horizontal movement or vertical movement of the first heating block 310 and the second heating block 320 to automate such operation of the heating blocks.

Referring to FIG. 2 to FIG. 5, the drive module 330 moves the first heating block 310 and the second heating block 320 in the vertical direction and the horizontal movement drive module 400 moves the first heating block 310 and the second heating block 320 in the horizontal direction to change the surface of the heating block contacting the surfaces of the reaction wells W on the PCR plate 200 to the first compressive surface G1 or the second compressive surface G2.

The first heating block 310 and the second heating block 320 are spaced apart from each other to be parallel to each other and are formed with guide grooves 312, 322 (see FIG. 2) each having a through-hole structure, and the first heating block 310 and the second heating block 320 are seated on the guide members 331, 332 penetrating the guide grooves 312, 322, respectively. With this structure, the first heating block 310 and the second heating block 320 may compress the upper surface of the PCR plate 200 while moving along the guide members 331, 332 in the vertical direction.

Obviously, the constant temperature plate 350 is disposed below the first heating block 310 and the second heating block 320 and may be moved to allow the region having the same temperature as the first temperature or the second temperature of the heating block to face the corresponding heating block such that the upper and lower surfaces of the PCR plate can be compressed thereby.

As described above, according to the present invention, the temperature control module 300 provides an advantage of allowing application of the first temperature and the second temperature to all PCR targets on the PCR plate 200 through the entire surface of the PCR plate, thereby realizing excellent effects in terms of application rate and reaction efficiency.

In addition, the heating blocks of the temperature control module 300 are generally placed above the PCR plate 200 so as to move horizontally and are lowered only upon compression of the PCR plate 200.

In order to realize the heating blocks, the first resilient member S1 may be inserted into the drive frame to impart resilient force that forces the heating blocks to move upwards. According to the present invention, in order to prevent application of excessive compressive force upon compression of the PCR plate 200, the temperature control module is provided with the second resilient member 335 that transfers compressive force (FIG. 5). In the embodiment shown in the drawings, the second resilient member 335 may be realized in a plate-spring structure and may exert constant buffering force to prevent excessive compressive force from being applied to the surface of the PCR plate 200 when the first and second heating blocks 310, 230 are compressed in the downward direction.

In addition, according to the present invention, the PCR plate 200 has a plate structure having the reaction wells on the upper surface thereof and the constant temperature plate 350 may be disposed under the PCR plate 200 to maintain the PCR plate at a constant temperature, for example, at a second temperature (for example: 55° C.).

This structure is adopted since internal amplification efficiency can be further improved when the PCR plate 200 rapidly reaches a target temperature in the case of increasing the temperature through close contact with the first heating block having the first temperature (for example: 95° C.) or the second heating block having the second temperature (for example: 55° C.) by the temperature control module 300.

Accordingly, in the embodiment of the invention, the constant temperature plate 350 may be further disposed under the PCR plate 200 to maintain the temperature of the PCR plate 200 at the second temperature.

In particular, although the constant temperature plate 350 according to this embodiment may be divided into the regions for application of the first temperature and the second temperature and may be horizontally movable as described above, it should be understood that the constant temperature plate 350 may be provided in a stationary type and may be set to a predetermined temperature.

FIG. 6 shows the constant temperature plate 350 horizontally moved to a lower side of the temperature control module through the horizontal movement drive module 400 in the structure shown in FIG. 2, and FIG. 7 shows the constant temperature plate 350 horizontally moved outwards to change the temperature regions in FIG. 6.

Specifically, in FIG. 6, when the first heating block 310 is disposed to apply the first temperature, the constant temperature plate 350 is horizontally moved to allow the first region thereof to be disposed under the PCR plate and the first heating block 310 is also horizontally moved to face the upper surface of the PCR plate 200. Thereafter, as shown in FIG. 7, when the constant temperature plate is horizontally moved to allow the second region thereof to be disposed under the PCR plate, the second heating block 320 is also horizontally moved to face the upper surface of the PCR plate 200.

Horizontal movement of the constant temperature plate 350 may be realized in a sliding manner by sliding tape that contacts a lateral side of the constant temperature plate 350.

In addition, referring to FIG. 6 and FIG. 7, which are conceptual views illustrating a bottom surface of the temperature control module 300 according to the present invention, the constant temperature plate 350 may be disposed between the PCR plate 200 and a scanning module (not shown) (500 in FIG. 1), and may be formed with a plurality of light transmission holes H, which have a through-hole structure and guide excitation light emitted from the scanning module to reach the PCR plate 200 and allow detection of fluorescence.

As such, the polymerase chain reaction device according to the present invention can realize nucleic acid extraction, PCR and detection in a single system equipped with the scanner and can provide a separable PCR plate for application to diagnosis of various diseases.

FIG. 8 to FIG. 13 show one embodiment of the PCR plate 200 according to the present invention.

Referring to FIG. 8 together with FIG. 2 and FIG. 3, the PCR plate 200 according to the present invention includes a body 210, an insertion portion 220, a flow channel 230, and a blocking member 240.

The body 210 includes one or more reaction wells W (W1 . . . Wn). The reaction wells W are formed on a surface of a plate shape and receives a PCR (polymerase chain reaction) preliminary mixture or a nucleic acid solution (hereinafter referred to as “nucleic acid solution”) supplied from the nucleic acid extraction cartridge 100 and receive a primer, a primer/probe, or a dried PCR mixture containing the primer/probe.

The insertion portion 220 extends from the body 210 to be inserted into the nucleic acid extraction cartridge 100 and is formed with an injection port h1, into which the nucleic acid solution is injected. The insertion portion 220 extends from one end of the body 210 and is inserted into the nucleic acid extraction cartridge 100 to be coupled thereto.

In particular, the insertion portion 220 may be formed with the injection port h1, into which the nucleic acid solution is injected from the nucleic acid extraction cartridge 100. In addition, the PCR plate 200 may be formed on the surface of the body 210 with the flow channel 230, which connects the injection port h1 to a plurality of reaction wells W.

Although FIG. 8 shows 8 reaction wells W1 to W8, it should be understood that the present invention is not limited thereto. The reaction well may be provided singularly or in plural and may be formed in a concave pattern by machining the surface of the body 210.

In particular, according to this embodiment, the surface of the body 210 may be divided into regions for the reaction wells W, as shown in FIG. 8, and a primer may be placed in a dried state in the reaction wells W to be mixed with the nucleic acid solution injected from the nucleic acid extraction cartridge 100 into the reaction wells W.

The flow channel 230 extends from the injection port h1 to the reaction wells W to allow the nucleic acid solution to flow from the injection port h1 to the reaction wells W along the flow channel 230. The blocking member 240 is mounted on the body 210 and blocks a reverse flow of the nucleic acid solution from the reaction wells W to the flow channel 230. The blocking member 240 includes an elastic material. The elastic material for the blocking member 240 may include rubber, silicone, and the like.

The body 210 may include a body frame 211, a blocking member-receiving portion 213, a connecting channel 215, a storage portion 217, and a channel guide 219. The body frame 211 is formed with one or more reaction wells W (W1 . . . Wn).

The blocking member-receiving portion 213 is concavely formed on the body frame 211 and receives the blocking member 240. In order for the blocking member-receiving portion 213 to receive the blocking member 240, the blocking member-receiving portion 213 is concavely formed corresponding to the size of the blocking member 240.

The connecting channel 215 connects the blocking member-receiving portion 213 to each of the reaction wells W. The nucleic acid solution may be supplied to the reaction wells W through the connecting channel 215.

The storage portion 217 is concavely formed on the body 210 to communicate with the flow channel 230 and receives the nucleic acid solution. The storage portion 217 stores the nucleic acid solution in order to supply the nucleic acid solution to each of the reaction wells W.

The channel guide 219 communicates with the storage portion 217 and guides the nucleic acid solution to flow towards the blocking member 240.

The connecting channel 215 has a bottleneck 215a formed from the blocking member 240 towards the reaction well W and having a narrow width. The bottleneck 215a is formed in an abruptly narrowed shape in the connecting channel 215 and has a structure in which a portion having the blocking member 240 received in the blocking member-receiving portion 213 slightly protrudes.

Referring to FIG. 10, the blocking member 240 is inserted into the blocking member-receiving portion 213 by downwardly compressing an upper portion of the blocking member 240, and the bottleneck 215a of the connecting channel 215 has a narrow width.

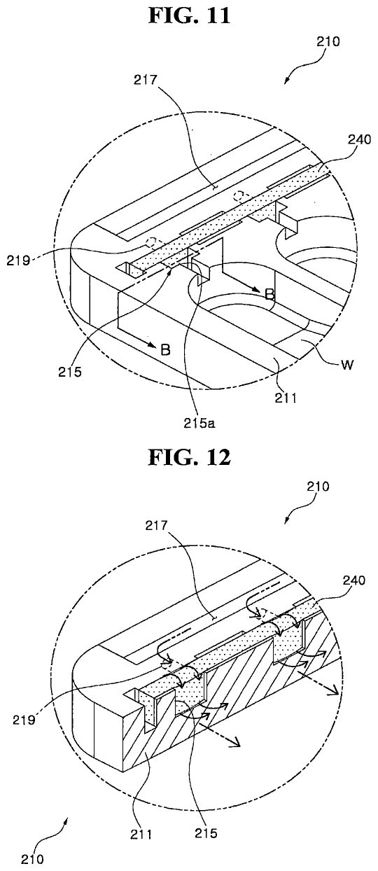

Referring to FIG. 11, when a transparent film is attached to the bottleneck 215a to seal the bottleneck 215a by compressing the transparent film thereon, four sides of the connecting channel 215 are compressed by the blocking member 240 to block the flow of the nucleic acid solution. Accordingly, the flow of the nucleic acid solution is blocked due to a slight pressure difference between adjacent reaction wells W.

Referring to FIG. 12, when the nucleic acid solution is continuously supplied to the blocking member 240, the nucleic acid solution is introduced into each of the reaction wells W while pushing the blocking member 240 after passing through the channel guides 219 from the storage portion 217.

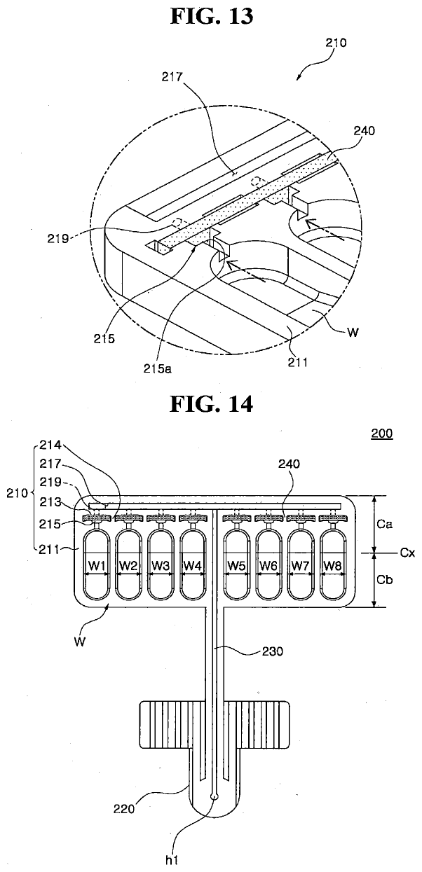

Referring to FIG. 13, when an inner pressure of the reaction wells W is increased due to change in temperature of the reaction wells W after the nucleic acid solution is introduced into each of the reaction wells W, the blocking member 240 is compressed by the pressure in the reaction wells W and is brought into close contact with the channel guides 219 and compresses the channel guides 219 to prevent a reverse flow of the nucleic acid solution from the reaction wells W to the flow channel 230.

In addition, the PCR plate 200 may include a cover member (not shown) that seals the plurality of reaction wells W. The cover member may be a film formed of a transparent material exhibiting light transmittance.

When the cover member is brought into close contact with the surfaces of the reaction wells W to form cavities in the reaction well W, the PCR (polymerase chain reaction) preliminary mixture or the nucleic acid solution supplied from the nucleic acid extraction cartridge 100 is injected into the reaction wells W while pushing air in the cavities.

In particular, according to the present invention, as shown in FIG. 8, the flow channel 230 connected to the reaction wells W in the body 210 may extend from the injection port h1 to a distal end of the body 210, at which the flow channel 230 is connected to each of distal ends of the plurality of reaction wells opposite the insertion portion 220.

That is, as shown in FIG. 2, when the PCR preliminary mixture or the nucleic acid solution is injected into the nucleic acid extraction cartridge 100 through the injection port h1, the flow channel 230 may be formed in a direction x1 across the body 210 and may be branched off to the left and right sides from the distal end of the body 210 to be connected to an inlet of each of the reaction wells W. With this structure of the flow channel, a thin air layer is present in each of the reaction wells W sealed by the cover member, so that the reaction wells W are filled with the PCR preliminary mixture or the nucleic acid solution from an upper region of the body 210 and the air layer is pushed towards a lower region Cb of the body 210 with reference to a central line Cx, when the PCR preliminary mixture or the nucleic acid solution are supplied to the reaction wells W, as shown in FIG. 8.

Accordingly, a mixture for PCR is disposed in the upper region Ca of the reaction wells W, and a region in which compression of the heating blocks 310, 320 occurs and a region in which detection of the scanner module occurs are also present in the upper region Ca thereof, as shown in FIG. 8, thereby improving detection accuracy, efficiency of PCR, and efficiency in temperature control.

In addition, according to the present invention, the PCR plate 200 may be formed of a synthetic material exhibiting high light transmittance. As the PCR plate is formed of a material having high light transmittance according to the function of the scanner module, it is possible to improve detection efficiency.

The material for the PCR plate may include various synthetic materials, such as transparent PP, PE, PPA, PMMA, PC, and the like, without being limited thereto. However, it should be understood that any material capable of securing a certain degree of light transmittance may be used as the material for the PCR plate.

The PCR plate 200 may be maintained at a constant temperature by heat applied from the constant temperature plate 350 disposed under the PCR plate and the body 210 may have a thickness in the range of 1.0 mm to 3.0 mm to secure efficiency in maintenance of the temperature of a PCR product, which contains the PCR preliminary mixture or the nucleic acid solution and at least one of a dried primer and a probe filling the reaction wells W, through the temperature control module. If the body has a thickness of less than 1.0 mm, heat for setting the first temperature can be easily transferred to a lower portion of the body 210, thereby making it difficult to achieve temperature control due to thermal interference with the constant temperature plate 350, and if the body has a thickness of greater than 3.0 mm, it is difficult to maintain a constant temperature due to difficulty in temperature control of the constant temperature plate 350 at the lower portion, despite ease of temperature control with respect to substances received in the reaction wells W.

That is, according to the present invention, as shown in FIG. 4 and FIG. 5, the first heating block 310 and the second heating block 320 are horizontally moved to control the temperature of the reaction product to the first temperature or the second temperature as a preset temperature by allowing the first compressive surface G1 or the second compressive surface G2 contacting the surfaces of the reaction wells W to compress an upper surface of a partition pattern and the cover member covering the partition pattern through contact therewith.

In addition, upon temperature cycling with respect to the PCR plate 200, in order to increase the temperature of the PCR plate to the first temperature, the first heating block 310 of the temperature control module 300 shown in FIG. 2 and FIG. 3 is horizontally moved to face the upper surface of the PCR plate 200 together with the constant temperature plate 350 horizontally moved to allow the first region thereof to be disposed under the lower surface of the PCR plate 200 and is then moved downwards to contact and compress the PCR plate 200, and, in order to reduce the temperature of the PCR plate to the second temperature, the second heating block 320 thereof is horizontally moved to face the upper surface of the PCR plate 200 together with the constant temperature plate 350 horizontally moved to allow the second region thereof to be disposed under the lower surface of the PCR plate 200 and is then moved downwards to contact and compress the PCR plate 200, whereby the upper and lower surfaces of the PCR plate 200 can be simultaneously heated or cooled. According to the present invention, the constant temperature plate 350 is integrally formed with the first and second heating blocks 310, 320 to move horizontally, thereby allowing the upper and lower surface of the PCR plate 200 to be simultaneously heated or cooled to the same temperature under the same pressure.

By such operation, the upper and lower surfaces of the PCR plate 200 can be simultaneously compressed through contact therewith, thereby realizing two times higher efficiency than the constant temperature plate 350 maintained at a constant temperature. As such, the upper and lower surfaces of the plate in a target can be simultaneously heated, thereby realizing an advantage of reducing an examination time by ½.

FIG. 14 to FIG. 19 show another embodiment of the PCR plate 200 according to the present invention.

Referring to FIG. 14 together with FIG. 2 and FIG. 3, the PCR plate 200 according to this embodiment includes a body 210, an insertion portion 220, a flow channel 230, and blocking members 240. For the body 210, the insertion portion 220, the flow channel 230, and the blocking members 240 of the PCR plate 200, refer to the above descriptions thereof.

In the PCR plate 200 according to this embodiment of the invention, the blocking member-receiving portion 213 is divided into a plurality of blocking member-receiving portions by partitions 214 formed in a longitudinal direction of the storage portion 217. The blocking members 240 are mounted on the blocking member-receiving portions 213 divided by the partitions 214, respectively.

Referring to FIG. 16, the plurality of blocking members 240 may be inserted downwards into the blocking member-receiving portions 213, respectively. The elastic blocking members 240 are press-fitted into the blocking member-receiving portion 213. The elastic blocking members 240 seal the blocking member-receiving portions 213, respectively.

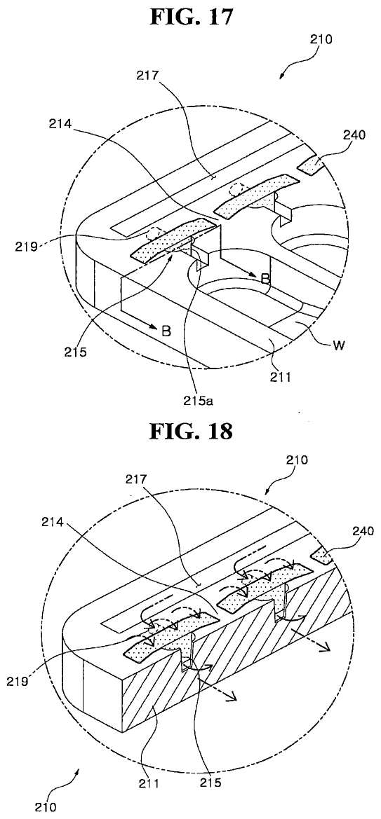

Referring to FIG. 17, after each of the blocking member-receiving portions 213 is sealed by the corresponding blocking member 240, flow due to pressure difference of the blocking member-receiving portion 213 is blocked by the partitions 214.

Referring to FIG. 18, when the nucleic acid solution is injected to the reaction wells W, the nucleic acid solution is introduced into each of the reaction wells W while pushing the blocking members 240 after passing through the storage portion 217 and the connecting channels 215.

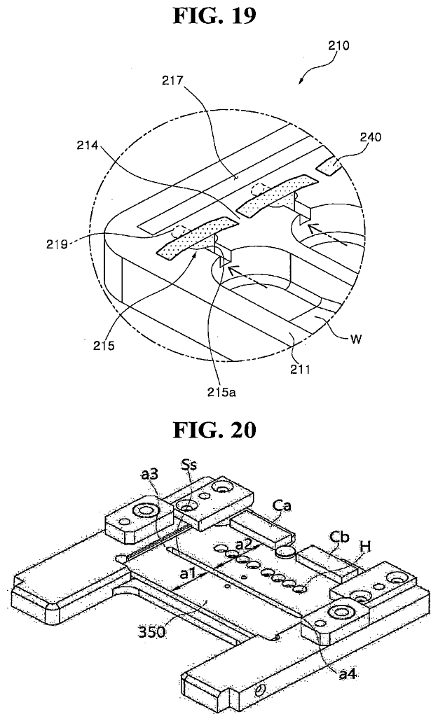

Referring to FIG. 19, when the pressure of each of the reaction wells W is increased due to change in temperature of each of the reaction wells W after the nucleic acid solution is introduced into the reaction wells W, the blocking members 240 are compressed in the reaction wells W. Then, the blocking members 240 are brought into close contact with the connecting channel 215 and compress the connecting channels 215 to block the reverse flow of the nucleic acid solution.

FIG. 20 to FIG. 23 are conceptual views illustrating the structure and operation of the constant temperature plate and the horizontal movement drive module.

FIG. 20 shows a seated state of the constant temperature plate 350 shown in FIG. 2 and FIG. 3, and FIG. 22 shows the constant temperature plate.

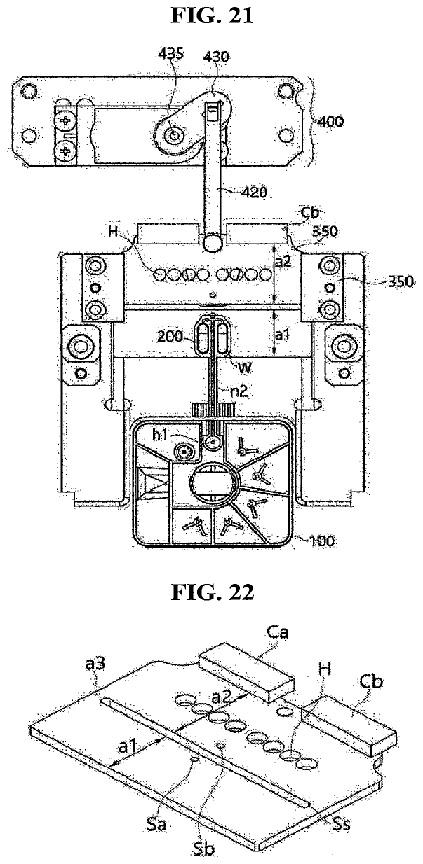

Referring to FIG. 20 and FIG. 21, the constant temperature plate 350 according to the embodiment of the invention is disposed under the heating blocks 310, 320 constituting the temperature control module 300 shown in FIG. 2 and FIG. 3 and may have the same temperature as the first heating block 310 or the second heating block 320 when the first heating block 310 or the second heating block 320 of the temperature control module 300 compresses the PCR plate 200 through horizontal movement or vertical movement after insertion of the PCR plate 200.

Referring to FIG. 20, the constant temperature plate 350 is divided into a first region a1 maintained at a first temperature and a second region a2 maintained at a second temperature by a separating portion Ss such that the first region a1 is connected to the second region a2 at both ends a3, a4 of the separating portion Ss.

The constant temperature plate 350 may be provided at one end thereof with connectors Ca, Cb to supply electric power and control signals.

In particular, horizontal movement of the constant temperature plate 350 is realized in a sliding manner by a sliding tape that contacts the lateral side of the constant temperature plate 350, thereby realizing simplification of the structure while improving movability.

In this case, the second region a2 is formed with the light transmission holes H to allow transmission of detection light therethrough when emitted from the scanning module 500 for scanning the concentration of an amplified reaction product.

The first region a1 and the second region a2 may be provided with temperature sensors Sa, Sb to measure and control the temperatures of the corresponding regions.

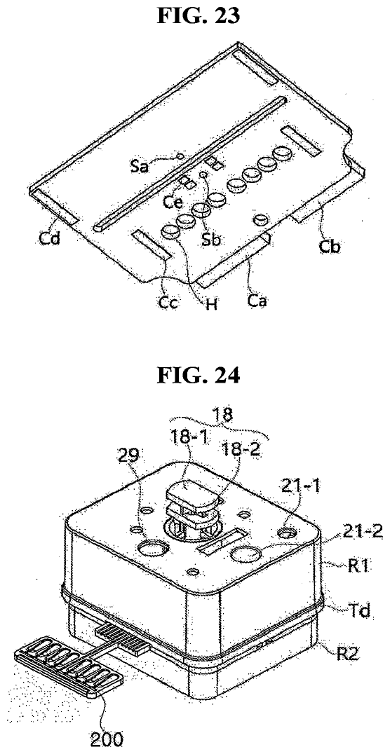

FIG. 23 is a bottom view of the constant temperature plate of FIG. 22, which is provided with the connectors Ca, Cb to supply electric power and control signals and with temperature sensors Sa, Sb to maintain the first temperature and the second temperature.

The temperature of the first region or the second region of the constant temperature plate 350 may be maintained by mounting various heating means such as heating wires, heating resistors, and the like, inside the plate. According to an exemplary embodiment of the invention, such an effect may be realized by forming circuits for electrodes or temperature sensors on an epoxy printed circuit board, coating a region between the electrodes with a heat generation paint, and bonding metal plates corresponding to the first region and the second region to the temperature sensors and the heat generation paint.

According to this invention, the constant temperature plate 350 may further include a horizontal movement drive module 400 that horizontally moves under the PCR plate 200.

As shown in FIG. 2 and FIG. 3, the horizontal movement drive module 400 may include the drive motor 410 and the moving bar 420 coupled to one end of the constant temperature plate 350, and the conversion plate 430 converting rotation of the drive motor 410 into horizontal movement of the moving bar 420, as described above.

Referring to FIG. 21, the PCR plate 200 is inserted into the nucleic acid extraction cartridge 100 to connect to the flow channel and the nucleic acid solution extracted from the nucleic acid extraction cartridge 100 is injected into the injection port h1. Thereafter, the nucleic acid solution is supplied to the PCR plate 200 including one or more reaction wells receiving a dried PCR mixture that contains at least one of a primer and a probe.

Thereafter, the first heating block 310 or the second heating block 320 of the temperature control module 300 is lowered onto the reaction wells of the PCR plate 200 to maintain the first temperature or the second temperature.

In this case, the horizontal movement drive module 400 horizontally moves the constant temperature plate 350 and the temperature control module 300 together, and the PCR plate 200 is disposed to be inserted into a space between the constant temperature plate 350 and the temperature control module 300.

When the heating blocks 310, 320 are horizontally moved by the horizontal movement drive module 400 and compress the PCR plate 200, the constant temperature plate 350 is disposed to allow the first region or the second region of the constant temperature plate 350 having a preset temperature (first temperature or second temperature) corresponding to the temperature of the heating block 310 or 320 to face the PCR plate 200.

That is, when the constant temperature plate 350 is horizontally moved to allow the first region a1 to be disposed under the PCR plate 200, the first heating block 310 (see FIG. 2) is also horizontally moved to face the upper surface of the PCR plate 200. Thereafter, the heating blocks 310, 320 are lowered to contact the upper surface of the PCR plate 200.

In addition, when the constant temperature plate 350 is horizontally moved to allow the second region a2 to be dispose under the PCR plate 200, the second heating block 320 (see FIG. 2) is also horizontally moved to face the upper surface of the PCR plate 200. Thereafter, the heating blocks 310, 320 are lowered to contact the upper surface of the PCR plate 200.

Specifically, upon temperature cycling with respect to the PCR plate 200, in order to increase the temperature of the PCR plate to the first temperature, the first heating block 310 is horizontally moved to face the upper surface of the PCR plate 200 together with the constant temperature plate 350 horizontally moved to allow the first region to be disposed under the lower surface of the PCR plate 200 and is then moved downwards to contact and compress the PCR plate 200

In order to reduce the temperature of the PCR plate to the second temperature, the second heating block 320 is horizontally moved to face the upper surface of the PCR plate 200 together with the constant temperature plate 350 horizontally moved to allow the second region to be disposed under the lower surface of the PCR plate 200 and is then moved downwards to contact and compress the PCR plate 200, thereby allowing the upper and lower surfaces of the PCR plate 200 to be simultaneously heated or cooled.

As such, the upper and lower surfaces of the PCR plate 200 are simultaneously compressed, thereby realizing two times higher efficiency than the constant temperature plate 350 maintained at a constant temperature.

Next, the nucleic acid extraction cartridge 100 providing a PCR preliminary mixture containing a nucleic acid extract or a nucleic acid solution to the PCR plate 200 will be described with reference to FIG. 24 to FIG. 32.

FIG. 24 is a perspective view of a nucleic acid extraction cartridge according to the present invention, into which the PCR plate is inserted. FIG. 25 is an exploded perspective view of the nucleic acid extraction cartridge and FIG. 26 is a view illustrating an inner structure of a cartridge cover R1 shown in FIG. 25.

Referring to FIG. 24 to FIG. 26, the nucleic acid extraction cartridge 100 according to the present invention may include the cartridge cover R1, which is formed with a plurality of receptacles 22, 23, 24, 25, 26 each containing a solution for DNA extraction and having a partition structure, and a cartridge body R2, which is coupled to the cartridge cover R1 through an insertion structure and formed with a reaction receptacle 11 in which the solution supplied from the receptacles 22, 23, 24, 25, 26 reacts with a specimen or is purified.

In this embodiment, the nucleic acid extraction cartridge 100 is provided with a piston 18, by which the PCR preliminary mixture or the nucleic acid solution purified in the reaction receptacle 11 is injected into the injection port h1 of the PCR plate 200 inserted into the cartridge body R2.

In the present invention, the cartridge cover R1 includes a rubber portion that contacts one side surface of the reaction receptacle 11 of the cartridge body R2 and includes an elastic material. The rubber portion 30 is formed of an elastic material, such as rubber, silicone, and the like.

According to the present invention, in assembly of the cartridge cover R1 and the cartridge body R2, the rubber portion 30 may seal a space between the cartridge cover R1 and the cartridge body R2 to prevent nucleic acid solutions from climbing up a wall of the reaction receptacle 11 of the cartridge body R2 and mixing with each other.

Next, operation of the nucleic acid extraction cartridge will be described with reference to FIG. 25 to FIG. 32. FIG. 27 is an inner perspective view of the nucleic acid extraction cartridge shown in FIG. 24 in a coupled state.

The nucleic acid extraction cartridge according to the present invention may be provided on a bottom surface of the cartridge body R2 with a rotary valve 19 having a flow path 19-1, which is formed on the rotary valve 19 and is connected to a space of each of receptacles 11, 12, 13, 14, 15, 16, 17 in the cartridge body R2 upon rotation of the rotary valve 19. The nucleic acid extraction cartridge is designed to take up a solution from a particular receptacle and transfer the solution to another receptacle or to the PCR plate 200 by actuating the piston 18 after connecting the flow path to the particular receptacle.

Referring to FIG. 25 and FIG. 26, the cartridge cover R1 is formed therein with the receptacles 22, 23, 24, 25, 26 each receiving a solution for DNA extraction and having a bottom surface, which is sealed with a film or the like and can be easily pierced by a penetrating needle of a body receptacle. In addition, the cartridge cover R1 is formed with five openings 21-1, 21-2, 27, 28, 29.

In the cartridge cover R1, a first receptacle 22 is filled with a binding buffer, a second receptacle 23 is filled with a first washing buffer, a third receptacle 24 is filled with a second washing buffer, a fourth receptacle 25 is filled with a third washing buffer, and a fifth receptacle 26 is filled with an elution buffer.

The PCR plate 200 is covered with a transparent plastic film, such as polyethylene, polypropylene, PET, and the like, and receives a dried PCR mixture including at least one of a dried PCR primer and a probe in the reaction wells, as described with reference to FIG. 8.

Operation of the nucleic acid extraction cartridge according to the present invention may be carried out in the following sequence.

### 1. Input of Biological Sample

The cartridge body R2, the cartridge cover R1 and the PCR plate 200 are mounted in a coupled state on automation equipment and a biological sample (blood) is input to a first opening 21-1 shown in FIG. 25.

### 2. Discharge of Nucleic Acids from Cell and Binding to Beads

As shown in FIG. 30, by rotation of the rotary valve 19 and operation of the piston 18 disposed at a lower portion of the cartridge body R2, the binding buffer is supplied from the first receptacle 22 to the reaction receptacle 11 and mixed with the biological sample and beads (silica-coated magnetic beads) of a magnetic tablet MT.

As used herein, the magnetic tablet MT is mounted on a distal end of a penetrating path extending into the reaction receptacle 11 of the cartridge body R2 and dissolves nucleic acids extracted from cells in the biological sample such that the dissolved nucleic acids are bound to the surfaces of the magnetic beads.

Here, a suspension of the magnetic beads in the binding buffer may be used instead of the magnetic tablet.

Thereafter, when ultrasound waves are applied to a sonication tip placed in the closed second opening 21-2 of the cartridge body R2, the ultrasound waves are transmitted through a plastic material to homogenize a reaction solution through mixing of the biological sample, the tablet and the binding buffer, in which biological tissues contained in the biological sample are also disrupted to release nucleic acids, which in turn are bound to the surface of the beads.

When a magnetic bar is placed in the third opening 27 of the cartridge body R2, the beads are secured to a wall of the reaction receptacle and remaining reactant is transferred to the first receptacle through rotation of the rotary valve and operation of the piston.

### 3. Primary Cleaning

The first washing buffer is supplied from the second receptacle 23 to the reaction receptacle 11 and is mixed with the beads bound to the nucleic acids through rotation of the rotary valve and operation of the piston of the cartridge body R2 shown in FIG. 27.

Then, the magnetic bar is removed from the third opening 27 shown in FIG. 25 and ultrasound waves are applied to the sonication tip placed in the second opening 21-2 to perform primary cleaning. By primary cleaning, substances non-specifically bound to the beads excluding the nucleic acids are removed.

The magnetic bar is placed in the third opening 27 to secure the beads to the wall of the reaction receptacle and a primary cleaning solution is transferred to the second receptacle 23 through rotation of the rotary valve and operation of the piston.

### 4. Secondary Cleaning

The second washing buffer is supplied from the third receptacle 24 to the reaction receptacle 11 and is mixed with the beads bound to the nucleic acids through rotation of the rotary valve and operation of the piston of the cartridge body R2 shown in FIG. 27.

Then, the magnetic bar is removed from the third opening 27 shown in FIG. 25 and ultrasound waves are applied to the sonication tip placed in the second opening 21-2 to perform secondary cleaning. By secondary cleaning, substances non-specifically bound to the beads excluding the nucleic acids are removed.

The magnetic bar is placed in the third opening 27 to secure the beads to the wall of the reaction receptacle and a secondary cleaning solution is transferred to the third receptacle 24 through rotation of the rotary valve and operation of the piston.

### 5. Tertiary Cleaning

The third washing buffer is supplied from the fourth receptacle 25 to the reaction receptacle 11 and is mixed with the beads bound to the nucleic acids through rotation of the rotary valve and operation of the piston of the cartridge body R2 shown in FIG. 27.

Then, the magnetic bar is removed from the third opening 27 shown in FIG. 25 and ultrasound waves are applied to the sonication tip placed in the second opening 21-2 to perform tertiary cleaning. By tertiary cleaning, substances non-specifically bound to the beads excluding the nucleic acids are removed.

The magnetic bar is placed in the third opening 27 to secure the beads to the wall of the reaction receptacle and a tertiary cleaning solution is transferred to the fourth receptacle 25 through rotation of the rotary valve and operation of the piston.

### 6. Elution of Nucleic Acid

The elution buffer is supplied from the fifth receptacle 26 to the reaction receptacle 11 and is mixed with the beads bound to the nucleic acids through rotation of the rotary valve and operation of the piston of the cartridge body R2 shown in FIG. 27.

Then, when the magnetic bar is removed from the third opening 27 shown in FIG. 25 and ultrasound waves are applied to the sonication tip placed in the second opening 21-2, the nucleic acids bound to the surfaces of the beads are dissolved in the elution buffer.

### 7. Generation of PCR Preliminary Mixture

The magnetic bar is placed in the third opening 27 to secure the beads to the wall of the reaction receptacle, the elution buffer containing the nucleic acids dissolved therein is placed in the sixth receptacle 17 through rotation of the rotary valve and selection of a small piston to be mixed with PCR substances [mixture, such as polymerase, dNTP, and the like] received in the sixth receptacle to generate a PCR preliminary mixture. As used herein, the PCR preliminary mixture is defined as a mixture realized by these substances.

### 8. Transfer to PCR Plate

The PCR preliminary mixture or the nucleic acid solution generated in the sixth receptacle are supplied to the PCR plate 200 and are mixed with at least one of a primer and a probe received in the PCR plate 200 through rotation of the rotary valve and operation of the piston of the cartridge body R2 shown in FIG. 27. Then, the resulting mixture is compressed and injected into the injection port h1 along the flow path Y of the rotary valve by the piston 18, as shown in FIG. 32.

Thereafter, a heating rod is placed in the fourth opening 29 to seal the PCR plate by compressing and heating a cover film at an inlet of the PCR plate.

### 9. PCR

Finally the PCR plate 200 contains the nucleic acids extracted from the biological sample, the polymerase, dNTP, at least one of the primer and the probe, and other buffering solutions.

Accordingly, PCR is carried out by application of pressure and heat to the PCR plate 200 through the temperature control module according to the present invention.

FIG. 33 to FIG. 36 show overall structure and arrangement of the polymerase chain reaction system according to the present invention described above.

The polymerase chain reaction device according to the embodiment of the invention may include a nucleic acid extraction cartridge assembly including the nucleic acid extraction cartridge 100 and the PCR plate 200.

Referring to FIG. 35, when the nucleic acid extraction cartridge 100 is mounted inside the polymerase chain reaction system according to this embodiment, the PCR plate 200 is seated on a side surface thereof. A portion of the body of the PCR plate 200 corresponding to the reaction wells is exposed and the temperature control module 300 is disposed above the portion.

FIG. 34 is an enlarged view of a main part of the polymerase chain reaction device shown in FIG. 33 and FIG. 35 is a vertical sectional view of the main part shown in FIG. 34. FIG. 36 is a lateral perspective sectional view of the main part shown in FIG. 35.

As shown in FIG. 34 to FIG. 36, a PCR preliminary mixture containing the extracted nucleic acids or a nucleic acid solution is supplied from the nucleic acid extraction cartridge 100 to the PCR plate 200 having the reaction wells W thereon. The first heating block 310 having the first compressive surface G1 corresponding to the surfaces of the reaction wells W of the PCR plate 200 and maintained at a preset temperature for thermal denaturation by the heating unit is disposed above the PCR plate 200 and the second heating block 320 having a region to be compressed also approaches the PCR plate 200 through horizontal movement thereof. Accordingly, the PCR preliminary mixture or the nucleic acid solution injected into the reaction wells W is directly heated to the first temperature (95° C.) for thermal denaturation or the second temperature (55° C.) for annealing by the heating blocks.

In addition, as shown in FIG. 35 and FIG. 36, the constant temperature plate 350 is disposed under the PCR plate 200 to maintain the temperature of the PCR plate 200 at a constant temperature.

The scanning module 500 is disposed below the constant temperature plate 350 such that light L emitted from a light emitting unit E1 reaches the PCR plate 200 via the light transmission holes H of the constant temperature plate 350 to allow detection of fluorescence light.

According to the embodiment of the invention, as described above, when the first heating block 310 having the first temperature (for example, 95° C.) is brought into close contact with the PCR plate to increase the temperature thereof or the second heating block 320 having the second temperature (for example, 55° C.) is brought into close contact therewith by the temperature control module 300, maintaining the constant temperature plate 350 at the second temperature is a very important factor for increasing reaction reliability, since it is very easy to control the temperature of an internal amplification reactant so long as the PCR plate 200 is maintained at a constant temperature. When the temperature of the PCR plate 200 is raised to 95° C., the first heating block is brought into close contact with the first constant temperature zone to increase the heat transfer rate, whereby the temperature of the PCR plate can rapidly reach 95° C. within 2 to 3 seconds.

Upon RT/PCR for detection of RNA targets, a PCR preliminary mixture containing dried RT-PCR product or the PCR plate is used. After adjustment to an RT reaction temperature, a low temperature block is brought into close contact with the PCR plate and maintained for an RT reaction time to perform PCR through reverse transfer reaction.

The presence of nucleic acids amplified through PCR or the concentration of the amplified nucleic acid may be determined and used in diagnosis. Here, determination as to the presence of the amplified nucleic acids or the concentration of the amplified nucleic acid may be achieved by a typical nucleic acid detection method.

For example, a method of using SYBR green as a DNA intercalation dye and a DNA minor grove intercalation dye, a method of scanning excitation light and corresponding fluorescence in different wavelength bands using probes with different fluorophores and phosphors attached thereto, or the like, may be used, without being limited thereto.

Referring to FIG. 37 to FIG. 44, according to another embodiment of the invention, the body 210 of the PCR plate 200 includes a body frame 211, a blocking member-receiving portion 213, and a connecting channel 215. The body frame 211 includes one or more reaction wells W (W1 . . . Wn).

The blocking member-receiving portion 213 is concavely formed on the body frame 211 corresponding to each of the reaction wells W and has a circular shape to receive a circular blocking member 240. In order for the blocking member-receiving portion 213 to receive the blocking member 240, the blocking member-receiving portion 213 is concavely formed corresponding to the size of the blocking member 240.

The connecting channel 215 connects the blocking member-receiving portion 213 to each of the reaction wells W. The nucleic acid solution may be supplied to the reaction wells W through the connecting channel 215.

The blocking members 240 may include an elastic material. The blocking members 240 are formed of the elastic material, such as rubber, silicone, or the like. Since the blocking member 240 disposed in each of the blocking member-receiving portions 213 is formed of a rubber and has a lower weight, the blocking member-receiving portion 213 undergoes small resistance upon injection of the nucleic acid solution into the reaction wells W.

Accordingly, the same amount of the nucleic acid solution is uniformly supplied to each of the reaction wells W through a single flow channel 230.

Referring to FIG. 43 and FIG. 44, each of the blocking member-receiving portions 213 is formed at a lower portion thereof with an opening, with which the blocking member 240 is brought into contact due to the weight thereof. When the pressure in each of the reaction wells W increases above the pressure in the connecting channel 215, the blocking member 240 may be brought into close contact with the opening of the blocking member-receiving portion 213 to act as a check valve that prevents a reverse flow of the nucleic acid solution.

FIG. 45 shows testing operation in the outermost reaction wells W1 and W8 among eight reaction wells W1 to W8. In order to check mixing of the nucleic acid solutions between the reaction wells in PCR, PCR was carried out after drying the reaction wells.

After 5, 15 and 25 minutes of PCR, the reaction wells W were checked and it was confirmed that the nucleic acid solution in one reaction well W was mixed with the nucleic acid solution in another reaction well W next to the one reaction well W over time. After 15 minutes of PCR, it was confirmed that the nucleic acid solutions in all of the reaction wells W1 to W8 were mixed.

FIG. 46 shows testing operation in the outermost reaction wells W1 and W8 among eight reaction wells W1 to W8. As a result of PCR after drying the outermost reaction wells, it could be confirmed that there was no mixing of the solutions between the reaction wells due to the check valve.

Referring to FIG. 37 to FIG. 41, the nucleic acid extraction cartridge 100 is formed with openings 21-1, 21-2, 27, 28, 29. Each of the openings 21-1, 21-2, 27, 28, 29 of the nucleic acid extraction cartridge 100 is provided with an anti-leakage rubber member 40. The anti-leakage rubber member 40 is formed of resilient rubber or the like.

The anti-leakage rubber members 40 serve to prevent the nucleic acid solution remaining in the nucleic acid extraction cartridge 100 from leaking through the openings 21-1, 21-2, 27, 28, 29 of the nucleic acid extraction cartridge 100.

Referring to FIG. 39, the anti-leakage rubber member 40 is punctured by a half-moon shaped punch 50 to form a hole through which air can enter the nucleic acid extraction cartridge.

Referring to FIG. 40, upon introduction of the nucleic acid solution, the anti-leakage rubber member 40 is pushed by a pushing jig 60 to allow efficient maintenance of atmospheric pressure through the hole of the anti-leakage rubber member 40.

Referring to FIG. 41, when the nucleic acid extraction cartridge 100 is closed, the anti-leakage rubber member 40 can prevent leakage of the nucleic acid solution remaining in the nucleic acid extraction cartridge 100 by closing the nucleic acid extraction cartridge 100.

Referring to FIG. 44, a sheet member 250 is joined to the reaction wells W by thermal fusion. Each of the reaction wells W is joined to the sheet member 250 by thermal fusion to maximize the volume of the reaction well W, whereby reaction of the nucleic acid solution can be rapidly carried out through rapid heat transfer in each of the reaction wells W.

Although the present invention has been described with reference to some example embodiments, it should be understood by those skilled in the art that these embodiments are given by way of illustration only and that various modifications, variations and alterations can be made without departing from the spirit and scope of the invention. Therefore, the scope of the invention should be defined by the following appended claims and equivalents thereto.

1. A PCR plate comprising:
a body having at least one reaction well;
an insertion portion extending from the body to be inserted into a nucleic acid extraction cartridge and having an injection port, into which a nucleic acid solution is injected;
a flow channel, along which the nucleic acid solution flows from the injection port to the reaction wells; and
a blocking member mounted on the body and blocking a reverse flow of the nucleic acid solution from the reaction well towards the flow channel.

2. The PCR plate according to claim 1, wherein the body comprises:
a body frame having the at least one reaction well;
a blocking member-receiving portion concavely formed on the body frame and receiving the blocking member therein;
a connecting channel connecting the blocking member-receiving portion to the reaction well;
a storage portion concavely formed on the body to communicate with the flow channel and receiving the nucleic acid solution supplied thereto; and
a channel guide communicating with the storage portion and guiding the nucleic acid solution to flow toward the blocking member.

3. The PCR plate according to claim 2, wherein the connecting channel has a bottleneck formed from the blocking member towards the reaction well and having a narrow width.

4. The PCR plate according to claim 2, wherein the blocking member-receiving portion is divided into multiple blocking member-receiving portions by a partition formed in a longitudinal direction of the storage portion and the blocking member is mounted on each of the divided blocking member-receiving portions.

5. The PCR plate according to claim 1, wherein the blocking member comprises an elastic material.

6. The PCR plate according to claim 1, wherein the body comprises:
a body frame having the at least one reaction well;
a blocking member-receiving portion concavely formed on the body frame, disposed corresponding to each reaction well, and formed in a circular shape to receive the blocking member having a circular shape; and
a connecting channel connecting the blocking member-receiving portion to the reaction well.

7. The PCR plate according to claim 6, wherein the blocking member comprises an elastic material.

8. The PCR plate according to claim 6, wherein a sheet member is joined to the reaction well by thermal fusion.

9. A nucleic acid extraction cartridge comprising:
a cartridge cover formed with a plurality of receptacles each receiving a solution for DNA extraction and having a partition structure; and
a cartridge body coupled to the cartridge cover through an insertion structure and formed with a reaction receptacle in which the solution supplied from the receptacle reacts with a specimen or is purified.

10. The nucleic acid extraction cartridge according to claim 9, wherein the cartridge cover comprises a rubber portion contacting one side surface of each of the receptacles of the cartridge body and comprising an elastic material.

11. The nucleic acid extraction cartridge according to claim 9, wherein the nucleic acid extraction cartridge is provided with an anti-leakage rubber member comprising an elastic material and preventing leakage of the nucleic acid solution.

12. A nucleic acid extraction cartridge assembly comprising:
a nucleic acid extraction cartridge; and
a PCR plate receiving a nucleic acid solution supplied from the nucleic acid extraction cartridge in a reaction well receiving a dried PCR mixture,
wherein the nucleic acid extraction cartridge comprises:
a cartridge cover formed with a plurality of receptacles each receiving a solution for DNA extraction and having a partition structure; and
a cartridge body coupled to the cartridge cover through an insertion structure and formed with a reaction receptacle in which the solution supplied from the receptacle reacts with a specimen or is purified, and
wherein the PCR plate comprises:
a body having at least one reaction well;
an insertion portion extending from the body to be inserted into the nucleic acid extraction cartridge and having an injection port, into which the nucleic acid solution is injected;
a flow channel, along which the nucleic acid solution flows from the injection port to the reaction well; and
a blocking member mounted on the body and blocking a reverse flow of the nucleic acid solution from the reaction well towards the flow channel.

13. The nucleic acid extraction cartridge assembly according to claim 12, wherein the cartridge cover comprises a rubber portion contacting one side surface of each of the receptacles of the cartridge body and comprising an elastic material.

14. The nucleic acid extraction cartridge assembly according to claim 12, wherein the nucleic acid extraction cartridge is provided with an anti-leakage rubber member comprising an elastic material and preventing leakage of the nucleic acid solution.

15. (canceled)

16. (canceled)

17. (canceled)
